(19) United States
(12) Patent Application Publication
(10) Pub. No.: US 2011/0261918 A1
(43) Pub. Date: Oct. 27, 2011

(54) Neutron and multi-neutron generator

(76) Inventor: Willard H. Schmidt, Albuquerque, NM (US)

(21) Appl. No.: 12/799,452

(22) Filed: Apr. 26, 2010

(51) Int. Cl. G21B 1/00

(52) U.S. Cl. 376/122; 376/121

(57) ABSTRACT

Neutrons and multi-neutron particles are generated in a specially configured solid iron electrical solenoid in which photoneutrons from a metallic strip irradiated by laser photons are selectively polarized and fused together. Nuclear binding energy is released by the nuclear reaction. These neutron generators can be joined in a series so that one feeds neutrons into the next neutron generator to increase the output neutron flux density.

### BACKGROUND OF THE INVENTION

This patent application is subsequent to my Feb. 12, 2009 patent application titled “Solid Iron Solenoid Neutron Initiator for Nuclear Reactor”. The present application utilizes a specially configured electrical solid iron solenoid and an optical laser to produce photoneutrons from a heavy metal target.

In November 2006, work was started on the ITER, International Thermonuclear Experimental Reactor located in Cadarche France. This is a version of the Tokamak thermonuclear nuclear fusion reactor invented in the 1950s by Russian scientists and worked on for years at Princeton and Los Alamos. This reactor is expected to produce more heat from nuclear fusion than is required to heat the plasma to fusion temperatures. Deuterium-tritium plasma instability is a major problem, and the ITER nuclear fusion project is expected to last for decades. The ITER thermonuclear fusion process is based on proton-proton fusion reactions. High temperatures and pressures are required to overcome the coulomb electrical barrier between two positively charged proton nuclear particles. The neutron nuclear fusion reactions of this subject invention are between electrically neutral neutron particles that have no electrical coulomb barrier to overcome. High temperatures and pressures are not required for neutron nuclear fusion reactions.

Neutron generators in the past have been based on alpha-neutron (α,n) nuclear reactions in radium-beryllium sources, and based also on hydrogen thermonuclear reactions in a deuterium-tritium high voltage accelerator.

### BRIEF SUMMARY OF THE INVENTION

The subject Neutron and Multi-Neutron Generator has an optical laser to produce photoneutrons from a thin heavy metal target. By virtue of their magnetic moment, these photoneutrons are anti-polarized in the magnetic field at a pole of a specially designed solid iron electrical solenoid. These anti-polar neutrons then strike polarized neutrons in iron atoms located at the opposite magnetic pole of the solid iron solenoid. These neutrons with opposite polarity then interact to form multi-neutron particles that can react with each other and with other neutrons to continue the process in a chain reaction fashion. The process can be either steady-state or pulsed mode.

These neutron generators can be stacked in a cascade, or series, so that one generator feeds neutron particles into the next neutron generator. One neutron generator is the source of neutrons for the next neutron generator in the series. Neutron output flux density is increased in this manner.

### BRIEF DESCRIPTION OF DRAWING

FIG. 1 titled “Laser Activated Neutron and Multi-Neutron Generator” is a cross section view of the entire assembly that shows all of the necessary components. The north and south magnetic poles of the solenoid are indicated by N and S on the drawing.

### REFERENCE NUMERALS IN DRAWINGS

1. Solid iron electrical solenoid
2. Electric cables
3. Laser
4. Photoneutron source material
5. Neutron moderator
6. Magnetic bridge

### DETAILED DESCRIPTION OF INVENTION

The purpose of this invention is to produce neutrons and multi-neutron particles that can be used to stimulate nuclear reactions in other nuclear systems, and to provide the means for releasing nuclear binding energy in certain nuclear configurations for commercial and industrial applications.

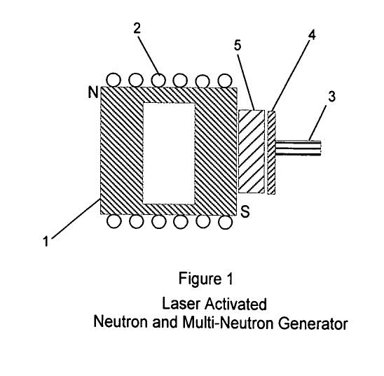

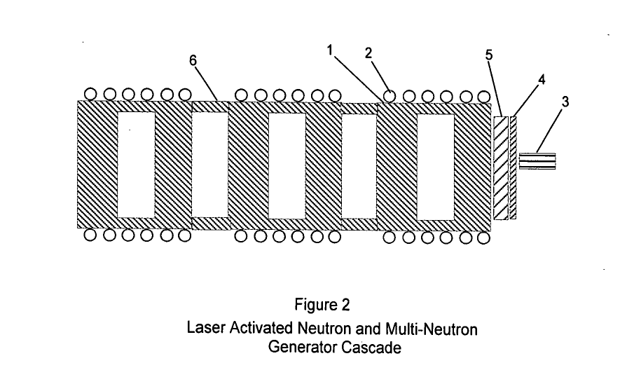

As shown in FIG. 1, there is a specially designed solid iron electrical solenoid 1 with electrical cables 2 wound around the outside surface to provide a magnetic field. To produce starter neutrons incident on solenoid 1, there is an optical laser 3, a layer of photoneutron source material 4, and a neutron moderator 5.

In FIG. 1 the specially configured solid iron electric solenoid 1 provides in itself both north and south magnetic poles that are used respectively, both for anti-polarizing incoming neutrons and for polarizing target neutrons in iron nuclei. Electric cables 2, wound on the exterior of the solid iron solenoid 1, provide electric current to generate the magnetic fields. Optical laser 3 is the source for photon radiation that impinges on photoneutron source material 4 to produce photoneutrons. These neutrons are slowed down in neutron moderating material 5, and subsequently enter the south magnetic pole of solid iron electric solenoid 1. In this south magnetic pole region, incoming incident neutrons assume an anti-polar orientation by virtue of their magnetic moment. These neutrons then flow to the north magnetic pole of solid iron solenoid 1 where they interact, or fuse, with polarized neutrons in the iron nuclei. This fusion of polar and antipolar neutrons forms a multi-neutron particle consisting of two neutron particles made into a single particle. Nuclear binding energy is released in this reaction. The new multi-neutron particle has zero angular momentum. Therefore, it is classified as a boson particle, and it is not subject to the Pauli exclusion principal. This new multi-neutron particle can then enter into reactions, or fuse, with other multi-neutron particles or with atomic neutrons in almost any element. These fusion reactions release large amounts of nuclear binding energy. This binding energy is available for many different applications. It can be used for industrial neutron nuclear fusion power plants, transportation vehicles, residential nuclear power plants, etc.

FIG. 2 shows neutron generators in a series, or cascade, mode. One neutron generator becomes the source of neutrons for the next neutron generator in the series. One neutron generator is joined to the next in the cascade by means of magnetic bridge 6.

Neutrons are fundamental particles that have no electric charge. Free neutrons are radioactive with a half-life of 10.6 minutes. Neutron particles have a diameter of 1.2×10⁻¹³ cm. They can penetrate solid iron. Neutrons and protons are called nucleons. They have half integer angular momentum, or spin. Therefore, they are classified as fermion particles, and they are subject to the Pauli exclusion principal which does not allow particles in an atomic nucleus to have the same set of quantum numbers. This problem is averted here in this invention because neutrons to be fused together are made to have opposite polarity in solid iron electric solenoid 1.

I claim:

1. A device for the generation of neutrons and multi-neutron particles.

2. A solid iron electrical solenoid of claim 1 with a special cut-away rectangular shape.

3. Electrical cables wound around the outer surface of the solenoid of claim 1 to provide a magnetic field for the solenoid.

4. A solid iron electrical solenoid of claim 1 with a south polar magnetic region to anti-polarize incoming neutrons, and a north polar magnetic region with polarized neutrons in iron atomic nuclei to serve as the target for the anti-polar neutrons from the south magnetic polar region.

5. An optical laser of claim 1 to provide incident photon radiation on photoneutron source material for the production of photoneutron particles.

6. A sheet of metallic material of claim 1 for the production of photoneutrons from the incident laser photon radiation.

7. A layer of neutron moderator material of claim 1 to slow down photoneutrons produced in the sheet of metallic photoneutron source material.

8. A process of claim 1 for the production of neutron particles and multi-neutron particles by means of photons from an incident laser beam on a metallic sheet of photoneutron source material to produce photoneutrons that become anti-polar in the south magnetic polar region of a solid iron electrical solenoid and impinge on neutrons polarized in the north magnetic polar region of the solenoid to promote neutron nuclear fusion reactions and form multi-neutron particles that can react among themselves and with neutrons in atomic nuclei to release large amounts of nuclear binding energy.

9. A cascade, or series, of neutron generators joined together by a magnetic bridge.
